(19) United States
(12) Patent Application Publication
(10) Pub. No.: US 2008/0264262 A1
(43) Pub. Date: Oct. 30, 2008

(54) SUPPORTING STRUCTURE FOR THE NOZZLE-SPRAYING PLANT OF A DROP SEPARATOR SYSTEM

(75) Inventors: Georg Neubauer, Dallgow-Doberitz (DE); Andre Voss, Neuruppin (DE); Udo Rossol, Sprockhovel (DE); Qiang Xu, Starnberg (DE)

Correspondence Address: BAINWOOD HUANG & ASSOCIATES LLC, 2 CONNECTOR ROAD, WESTBOROUGH, MA, 01581, US

(73) Assignee: REA PLASTIK TECH GMBH, Neuruppin (DE)

(21) Appl. No.: 12/061,221

(22) Filed: Apr. 2, 2008

Related U.S. Application Data
(63) Continuation of application No. PCT/EP2006/009894, filed on Oct. 13, 2006.

(30) Foreign Application Priority Data
Oct. 14, 2005 (DE) 10 2005 049 164.2

(51) Int. Cl. B01D 47/00

(52) U.S. Cl. 96/243

(57) ABSTRACT

Flue-gas scrubber, comprising at least one horizontally installed drop separator module mounted by means of carrying beams and at least one nozzle-spraying plant having at least one nozzle-spraying pipe, the at least one nozzle-spraying plant being designed with a supporting structure for the nozzle-spraying pipes, characterized in that the supporting structure is designed with at least one suspension which at least partially surrounds a carrying beam and which has for at least one carrying bar mountings projecting on both sides of the carrying beam, this at least one carrying bar serving as a rest for the at least one nozzle-spraying pipe.

### CROSS REFERENCE TO RELATED APPLICATIONS

This Patent Application is a Continuation of PCT application PCT/EP2006/009894 filed Oct. 13, 2006 and entitled “Supporting Structure For The Nozzle Installation Of A Mist Eliminator System”, the contents and teachings of which are hereby incorporated by reference in their entirety.

### BACKGROUND

The present invention relates to a supporting structure for a nozzle-spraying plant of a drop separator system of a flue-gas scrubber, specifically, in particular, the supporting structure for the nozzle-spraying pipes for the drop separator modules which are mounted horizontally on carrying beams in this flue-gas scrubber. The invention is employed particularly in flue-gas desulphurization.

The combustion of coal gives rise, inter alia, to the gas sulphur dioxide which is an essential cause of the death of forests. There are various methods for extracting the harmful sulphur dioxide from the flue gas. The wet method, as it is known, is used most often. In this, the unpurified flue gas is sprayed in a scrubbing tower, also called an absorber tower or gas scrubber, with a mixture of water and limestone, what is known as a scrubbing suspension, with the result that the sulphur dioxide is largely absorbed due to chemical reactions. It is thus possible to achieve a degree of desulphurization of more than 90%. In this case, the gaseous sulphur dioxide first dissolves in the scrubbing liquid. Subsequently, due to the reaction of sulphur dioxide and limestone, calcium sulphite and carbon dioxide are obtained. A scrubbing suspension laden with calcium sulphite collects in the lower part of the scrubbing tower, in the absorber sump. By the injection of air (oxidation), the liquid is enriched with oxygen, and a gypsum suspension is obtained. After the extraction of the water, gypsum with up to 10% residual moisture occurs in pourable form and is available as a useful product for delivery to the building materials industry.

As a rule, drop separators are installed downstream of the gas scrubbing in the gas flow direction and cover the entire cross section of the round or angular gas scrubber tower. The drop separator is in this case formed by curved lamellae which lie parallel to and at a defined distance from one another and on which the drops containing the gas flow are precipitated. The precipitated drops form a liquid film which, obeying the law of gravity, flows off downwards or falls in large drops downwards counter to the gas stream.

Since flue gas is heavily laden with fly ash and gypsum is formed during the further desulphurization process, there is always the risk that these solid particles are deposited on the drop separator and may possibly even block the latter. Consequently, below the respective separator layer and often also above it (downstream of the drop separator in the gas flow direction), scavenging devices are installed, which periodically wash the drop separator lamellae and eliminate possible deposits. This scavenging device consists, inter alia, of pipes with nozzles inserted in them.

Drop separators, in a flat type of construction or with a V-shaped arrangement of inclined drop separator lamellae, have proved beneficial both with regard to cleaning off and keeping clean and in terms of a reliable separation performance. The drop separator lamellae of streamlined shape deflect the gas stream laden with liquid. The drops cannot perform this deflection because of their inertia, but, instead, rebound on the drop separator lamellae (rebound-surface separator). In this case, a liquid film occurs, which then runs off downwards. In order to adapt the performance to the set object, drop separators with special shapes and properties are offered. This ensures the reliable removal of the liquid, while at the same time ensuring a high separation performance.

A flue-gas scrubber is normally equipped with two or with three drop separator layers which are mounted in each case on a carrying beam structure. The carrying beam structure usually comprises a plurality of carrying beams which extend over at least part of the cross section of the flue-gas scrubber and which absorb a substantial fraction of the weight of the drop separator layers fastened to them. These drop separators consist of a multiplicity of identically constructed modules which each have a multiplicity of lamellae.

In the interspaces between the drop separator layers, below the lowermost drop separator layer and sometimes also above the uppermost drop separator layer, pipelines with nozzles are provided, which are used for washing the drop separators while the flue-gas scrubber is in operation. Washing water is sprayed by means of the nozzles onto the drop separators or their lamellae, with the result that these are freed of the solids which adhere there and which, coming from the flue-gas stream, have settled on the surface. A supporting structure is required in order to position these pipelines and nozzles in relation to the respective drop separator layer.

This supporting structure, in the art known hitherto, either is designed as part of the carrying beam structure with carrying bars lying on it or is mounted as an independent carrying structure on this.

In the version as part of the carrying beam structure, supporting bars (steel) are attached vertically to the carrying beams and firmly connected (welded) to these. These supporting bars have mounted on them, in turn, carrying bars which run parallel to the carrying beams and lie on the carrying beam structure and on which the nozzle-spraying pipes then lie. The carrying bars, which are produced, for example, from GFRP (glass-fiber-reinforced plastic), are usually fastened to the supporting bars by means of screws consisting of high-grade alloy steel. The nozzle-spraying pipes are connected to the carrying bars by means of stirrup pieces usually consisting of high-grade alloy steel.

The independent carrying structure is usually produced from GFRP material and comprises, for example, a clip structure, supporting bars and carrying bars and also pipe stirrup pieces. The clip structure is fastened to the main carrying beam and serves as a base for the supporting bars. The supporting bars are mounted, together with this clip structure, onto the carrying beams and anchored. The carrying bars are fastened to the supporting bars (as in the type described above), and the pipes are fastened, in turn, to the supporting bars.

A critical disadvantage of these designs is that the supporting structure impedes the walk-on capability of the plant. The walk-on capability is usually provided in that the carrying beams form a footway, via which the personnel can approach the drop separators. In the known structures, pipelines and carrying bars form a closely meshed grid of obstacles in this region. Inspections and manual cleaning are thereby impeded considerably.

This also has considerable safety aspects, since these obstacles prevent the walk-on personnel from always remaining exactly in line with the carrying beam during inspection. This is impossible because, exactly above the 200 mm to 300 mm thick carrying beam, there are usually carrying bars of a height of 500 mm to 600 mm which prevent the personnel from walking upright. For safety reasons, however, it is desirable that the personnel should move about on the carrying beam, since, when parts of the drop separator modules are walked upon, there is the risk that these do not carry the operating personnel and break. The drop separator modules consist of polypropylene lamellae which are damaged after a few years due to the action of heat in the flue-gas scrubber (40° to 60° C.). By being damaged, the module loses carrying force, so that there is the risk of it breaking through. Persons will then fall through the drop separator from a height of 25 m to 35 m into the sump having a temperature of 60°.

A further problem often arises due to the limited dimensional accuracy of the flue-gas scrubber build. A 12 m to 18 m round flue-gas scrubber is in actual fact not actually round, but usually has an unforeseeable deviation from the round shape. However, the known supporting structures require the carrying structure to be installed before the installation of the drop separator modules.

Due to the lack of dimensional accuracy of the flue-gas scrubber, this leads unavoidably to dimensional conflicts. These then have to be eliminated by reworking in a time-consuming way.

Furthermore, the known supporting structures are highly susceptible to damage due to mounting and caused by being walked upon later. The supporting bars are produced in the welded form as steel bars with a rubber coating. In the event of improper treatment during mounting or during subsequent work, the rubber coating may be damaged. This means that the steel is exposed directly to the flue gas containing sulphuric acid. The corrosion which then sets in at once destroys these supporting structures after even only a short time. As a result, the functioning capacity of nozzle-spraying may be disturbed and further consequential damage may arise. This damage may not only lead to considerable costs, but also result in a reduction in the power output of the power station.

A final disadvantage is the wide supporting distances between the carrying bars of the known supporting structures. These correspond to the distance between two carrying beams and are consequently more than 2000 mm. This is no problem with the GFRP nozzle-spraying pipelines normally used. However, it is a problem with regard to polypropylene pipelines which are increasingly used. For polypropylene pipelines, supporting distances of more than 2000 mm are a disadvantage, since these lead to a considerable sagging of the pipelines. Polypropylene pipes, at temperatures above 40° C., do not have the necessary stability for the supporting widths of more than 2000 mm. The sagging of the pipelines may lead to damage to the pipes, in particular at the welds, and to deficiencies in terms of the washing function (the nozzle-spraying of the entire surface is possibly no longer ensured). Both of these lead to an increasing contamination of the drop separator modules, which, under certain circumstances, results in a load reduction or even may make it necessary to shut down the power station.

An idea which differs from the conventional supporting structures is described in WO 2004/033071. Here, the supporting structure is no longer part of the carrying structure, but part of a drop separator module, the supporting structure preferably being produced with polypropylene or with polypropylene-coated steel. This type of supporting structure has three decisive advantages:

Installation is made markedly easier, since the supporting structure for the nozzle-spraying pipes is in this case designed as part of the drop separators and can be introduced, together with this, into the flue-gas scrubber. The dimensional deviations of the non-round flue-gas scrubber consequently no longer play a substantial role.

The supporting structure no longer necessarily runs parallel to the carrying beams, but at an angle of 90°, thus making it possible to walk on the carrying beams without major problems.

The supporting distance for the nozzle-spraying pipes can be markedly reduced and it is possible to use cost-effective polypropylene without risk.

However, the markedly higher costs of the supporting structure and method-related difficulties are a disadvantage. The supporting structure has to be integrated in a complicated way into the drop separator modules and reduces the area available for separation. This is particularly important because the drop separators designed according to this method operate at the performance limit in many plants. Horizontally built drop separators can be operated effectively only at gas velocities of up to 5.5 m/s. If this velocity is overshot, a liquid breakaway, as it is known, occurs and the separation function is no longer afforded. The blocking of part of the area available for the separation function by the structure described in WO 2004/033071 leads to an increase in velocity in the remaining area and consequently increases the risk of the failure of the drop separator.

### SUMMARY

Proceeding from this, the object of the present invention is at least partially to solve the technical problems outlined with reference to the prior art. In particular, a supporting structure is to be specified, which indicates solutions for at least a better walk-on capability of the carrying beams, for lesser installation problems, for effective operation of the drop separators and/or for higher operating reliability.

These objects are achieved by means of a supporting structure for a scavenging device of a drop separator system, having the features of Patent Claim 1. Further advantageous refinements are specified in the dependently formulated patent claims, and in this case the individually listed features may be combined in any desired technologically expedient way and indicate further refinements of the invention.

The flue-gas scrubber according to the invention comprises at least one horizontally installed drop separator module mounted by means of carrying beams and at least one nozzle-spraying plant having at least one nozzle-spraying pipe. The at least one nozzle-spraying plant has a supporting structure to the nozzle-spraying pipes, this being designed with at least one suspension which at least partially surrounds a carrying beam and which has for at least one carrying bar mountings projecting on both sides of the carrying beam, this at least one carrying bar serving as a rest for the at least one nozzle-spraying pipe. Preferably, the suspension lies on the carrying beam without a non-positive or materially integral connection, that is to say a captive fastening may be dispensed with. Consequently, the supporting structure can be arranged as a separate component group of the drop separator modules on the carrying beams. It thus becomes possible that the mounting of the supporting structure can be carried out independently of that of the drop separator modules. Also, defective drop separator modules can be exchanged cost-effectively and in a time-saving way, without the supporting structure having to be machined or partially demounted. This may be achieved in that the supporting structure carries essentially only the nozzle-spraying plant, that is to say, in particular, not the drop separator modules.

What is described is, in particular, a flue-gas scrubber with a horizontally installed drop separator having two to four nozzle-spraying layers, which is equipped with a supporting structure for the nozzle-spraying pipes of the drop separators. The supporting structure is also characterized, where appropriate, in that it is suspended from the carrying beams and the side ring without any connection to the drop separator modules.

Flue-gas scrubbers are advantageous in which the suspension is designed in the form of a “U”, this being arranged with mountings projecting downwards beyond the carrying beam. The supporting structure is therefore formed by a suitably arranged plurality of suspensions which lie in the manner of an upturned “U” on one or more carrying beams. The suspension itself may be produced as one part or with a plurality of assembled parts. Preferably, in the suspension, corrosion-resistant and/or corrosion-protected materials are to be selected, which, in particular, withstand the ambient conditions of a flue-gas desulphurization plant.

In this respect, it is preferred that the suspension is formed by at least one plastic plate. There are, in particular, 3 plastic plates which are joined to one another by means of plastic welding. The plastic comprises, in particular, a thermoplastic, such as, for example, polypropylene and, most particularly preferably, polypropylene homopolymers. Taking into account the load to be carried and the loads arising from the ambient conditions (for example, temperatures permanently above 60° C. or even above 80° C.) the material preferably has at least one of the following characteristic values: a material thickness in the range of 8 mm to 10 mm; a width in the direction of extent of the carrying beam in the range of 150 mm to 250 mm (in particular, in a range of 180 mm to 220 mm).

Advantageously, the flue-gas scrubber has a plurality of suspensions which lie on a carrying beam and are spaced apart in the direction of extent of the carrying beam by means of distance plates. The distance plates are preferably flat plates with an extent in the direction of extent of the carrying beam of approximately 1000 mm to 1200 mm. The distance plates are preferably produced from the same material as or a similar material to the suspension and may likewise be covered with at least one (for example, rubber-like) protective layer. Between such distance plates, which also serve for protecting the carrying beams when these are walked upon, the suspensions are positioned (with some play) in the direction of extent of the carrying beams.

It is also possible that, in the flue-gas scrubber, at least two suspensions are connected to one another by means of, for example, rectangular carrying bars. These carrying bars then serve as a carrying structure for the nozzle-spraying pipes, which is laid onto these or is suspended from these by means of corresponding pipe clips.

It is also advantageous that, in the preferred form of construction, the rectangular carrying bars lie parallel to the carrying beams, or that the rectangular carrying bars lie at an angle of 90° to the carrying beams. In this case, the nozzle-spraying pipes lie preferably at an angle of 90° to the rectangular carrying bars and consequently either parallel to or at an angle of 90° to the carrying beams.

Furthermore, it is proposed that the carrying structure be held at the intended location by virtue of its own weight and its shape and can therefore be removed again at any time with little outlay.

According to a development, the pipes are secured against jumping out only by means of mountings having screws and stirrup pieces or having clips.

In the flue-gas scrubber according to the invention with a horizontal drop separator, the known technical problems are partly solved in that the supporting structure for the nozzle-spraying pipes are not fastened either to the carrying beams or to the drop separators (as in the invention of WO 2004/033071 A1), and, at the same time, a pipe routing parallel to the main carrying beams becomes possible, but is not mandatory.

The decisive difference between the solution according to the invention and the prior art listed in the introduction is that the supporting structure for the nozzle-spraying pipes is not connected directly to the structure of the flue-gas scrubber (for example, the main carrying beams). Further, the nozzle-spraying pipes run parallel to the carrying beams, and the supporting structure is configured such that it is possible to walk on the drop separator easily, without the personnel leaving the carrying beams and without obstacles having to be overcome. The space above and below the carriers is kept free owing to the proposed design. The supporting structure lies between the carriers and leaves free a path for walking on the carrying beams which is not partially blocked by supporting elements or by carrying bars running in the transverse direction from these.

The supporting distances may be configured, as desired, so that an overstretching of the polypropylene nozzle-spraying pipes is avoided. The structure is introduced only after the building of the flue-gas scrubber and does not force the manufacturer of the flue-gas scrubber to take this structure into account or to prepare for this installation. Instead, this supporting structure can be adapted to the existing situation without any outlay.

The structure nevertheless does not form a unit with the drop separator, as in the invention of WO 2004/033071 A1. Instead, the structure is completely separate from the drop separator module and is installed in the flue-gas scrubber separately and before the drop separator.

The result of this is that there is no reduction in the separation area and, consequently, also no undesirable increase in velocity of the flue-gas stream. Further, the supporting structure described here is considerably more cost-effective than the conventional configuration described.

In the embodiment which is preferably used, a polypropylene plate is cut into strips with a width of 200-300 mm and a U-shaped structure with long arms is built from these either by bending on an edging bench or by the welding of three part-plates. This U-shaped structure is then suspended via the carrier beam. Holes or incisions have previously been cut at the (then downwardly hanging) ends of this suspension, thus providing mountings, into which a rectangular tube (carrying bar) can be inserted or introduced.

The carrying bar is manufactured from a rectangular steel tube which is covered with a polypropylene layer (rectangular tube consisting of polypropylene) and which is therefore protected from sulphuric acid. This polypropylene layer is closed, gas-tight, at the ends by means of polypropylene caps. Pipe clips or pipe mountings are fastened to the carrying beams by welding, screwing or other fastening methods.

The carrying bar is inserted or introduced into the prepared holes or incisions of the suspension and is then firmly detained in this by means of bolts or screws. The nozzle-spraying pipes can then be introduced into pipe clips or pipe suspensions on the or below the carrying bars.

In the preferred embodiment, the carrying bars are installed perpendicular to the carrying beams, so that the nozzle-spraying pipes then run again parallel to the carrying beams.

In another embodiment, however, the carrying bars are laid parallel to the carrying beams. In this design, the nozzle-spraying pipes then run perpendicularly to the carrying beams. In this embodiment, the two arms of a suspension are closed at the bottom by means of a structure and the rectangular tube is not suspended through the arms, but between the arms of the suspension.

In another embodiment, the suspensions are shaped with only one arm. This design is necessary for suspension from the side ring, as it is known. This is the carrying ring which runs along the power station wall and on which the end modules lie. This side suspension has to be fastened to the side ring so that the load of the carrying bars and pipes can be carried. Even the weight of the drop separator module standing on the suspension is sufficient for this. Nevertheless, for safety purposes, the suspension may be fastened to the side ring by means of a polypropylene screw with a nut. For this purpose, the side ring must be provided with corresponding holes. Other holding-down concepts may also be employed.

A further embodiment provides for upwardly directed polypropylene plates also to be attached to the suspensions. These serve as a base for a supporting structure for the fourth nozzle-spraying level sometimes used. In this design, the suspension has welded to it a polypropylene plate to which the supporting bars of the fourth nozzle-spraying level can be attached (screwed). These may be constructed in a conventional welded design or be assembled from components on the building site. A supporting structure will normally always span three carrying beams in order to achieve the necessary stability.

The supporting structure is to be designed such that a uniform supporting distance for all the pipe parts is achieved.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 shows a basic illustration of a drop separator/suspension structure,

FIG. 2 shows an illustration of a separator level with a suspension,

FIG. 3 shows a front view of such a suspension structure,

FIG. 4 shows an illustration of a spacer for the lamellae,

FIG. 5 shows a flue-gas scrubber with a suspension structure,

FIG. 6 shows a detail of a flue-gas scrubber with this structure,

FIG. 7 shows a design variant of the supporting structure according to the invention with a suspension,

FIG. 8 shows a top view of a variant of the supporting structure according to the invention with a suspension, and

FIG. 9 shows a top view of a flue-gas scrubber without drop separator.

### DETAILED DESCRIPTION

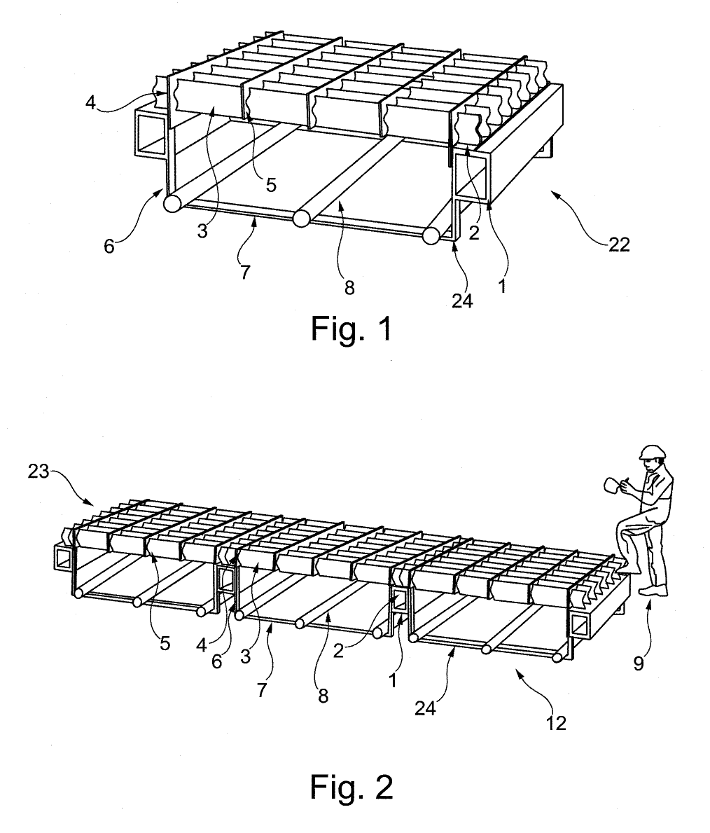

FIG. 1 shows a perspective front view of a drop separator module 22 with suspension 6, carrying bar 7 and three nozzle-spraying pipes 8. The drop separator module 22 consists of 5 milled plates, two end plates 4 and three middle plates 5, through which are plugged a relatively large number of lamellae 3, through which the flue gas flows and which at the same time deflect the flue-gas stream, in order thereby to achieve the separation of the liquid drops contained in it. The drop separator module 22 lies on two carrying beams 1. The drop separator modules 22 lie on a rest 2 which has plastic plates which protect the rubber-coated or otherwise coated surface of the carrying beam 1. The supporting structure 24 or the suspension 6 hangs down from the carrying beam 1 and, in turn, holds a rectangularly configured carrying bar 7 on which the nozzle-spraying pipes 8 lie.

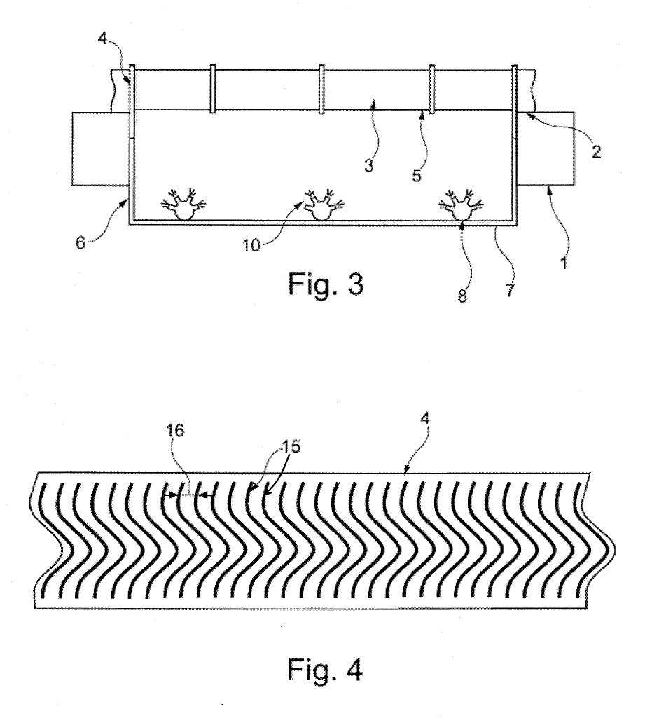

FIG. 2 shows several modules of a drop separator 23 on several carrying beams 1 and also the idealized outlines of a person 9 so as to illustrate the size relationships. The drop separator modules are constructed, as described with reference to FIG. 1. The horizontally installed drop separator modules 22 mounted by means of carrying beams 1 have a supporting structure 24, by means of which their nozzle-spraying plant 12 is brought into the desired position.

FIG. 3 shows a front view of a drop separator module and of the suspension 6. The drop separator module consists of five milled plates, two end plates 4 and three middle plates 5, through which are plugged the profiles 3, through which are plugged a relatively large number of lamellae 3, through which the flue gas flows and which at the same time deflect the flue-gas stream, in order thereby to achieve the separation of the liquid drops. The module lies on two carrying beams 1. The modules lie on a rest 2 which has plastic plates which protect the rubber-coated or otherwise coated surface of the carrying beam. The suspension 6 hangs down from the carrying beams 1 and, in turn, holds a rectangular tube on which the nozzle-spraying pipes 8 lie. In addition, here, the spraying nozzles 10 are shown, by means of which the drop separator is sprayed with the washing water.

FIG. 4 shows an end plate 4 in the preferred designed form of the connection and holding of the lamellae 3. The profiles are plugged through prepared slots 15 which are arranged at equal distances 16 in the plate. The multiplicity of lamellae arranged correspondingly parallel to and at a defined distance from one another form the entire drop separator. This is, of course, subdivided for installation reasons into modules of a defined length and width.

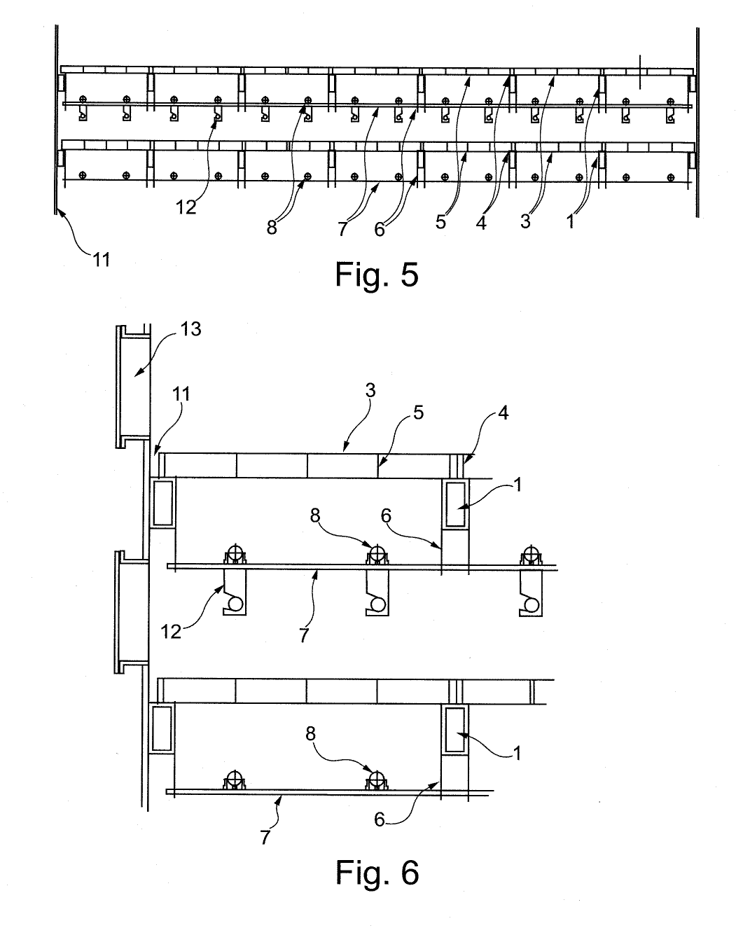

FIG. 5 shows a cross-sectional drawing of an absorber with two drop separator and three nozzle-spraying layers 12. The drop separator modules consist in each case of five milled plates, two end plates 4 and three middle plates 5, through which are plugged a relatively large number of lamellae 3, through which the flue gas flows and which at the same time deflect the flue-gas stream, in order thereby to achieve the separation of the liquid drops. The module lies on two carrying beams 1. The suspension 6 hangs down from the carrying beams and, in turn, holds a rectangular tube 7 on which the nozzle-spraying pipes 8 lie. The wall 11 of the flue-gas scrubber delimits the drop separator layer on both sides. Further, in addition to the pipelines hanging down, already described, a further third nozzle-spraying pipe layer 12 can be seen between the two drop separator layers. This sprays washing water downwards onto the drop separator lying underneath.

FIG. 6 shows this cross-sectional drawing once in detail. The drop separator modules consist in each case of five milled plates, two end plates 4 and three middle plates 5, through which are plugged a relatively large number of lamellae 3, through which the flue gas flows and which at the same time deflect the flue-gas stream, in order thereby to achieve the separation of the liquid drops. Further, between the two drop separator levels, a further third nozzle-spraying pipe layer 12 can be seen. This sprays washing water downwards onto the drop separator lying underneath. Two manholes 13 are depicted in the scrubber wall.

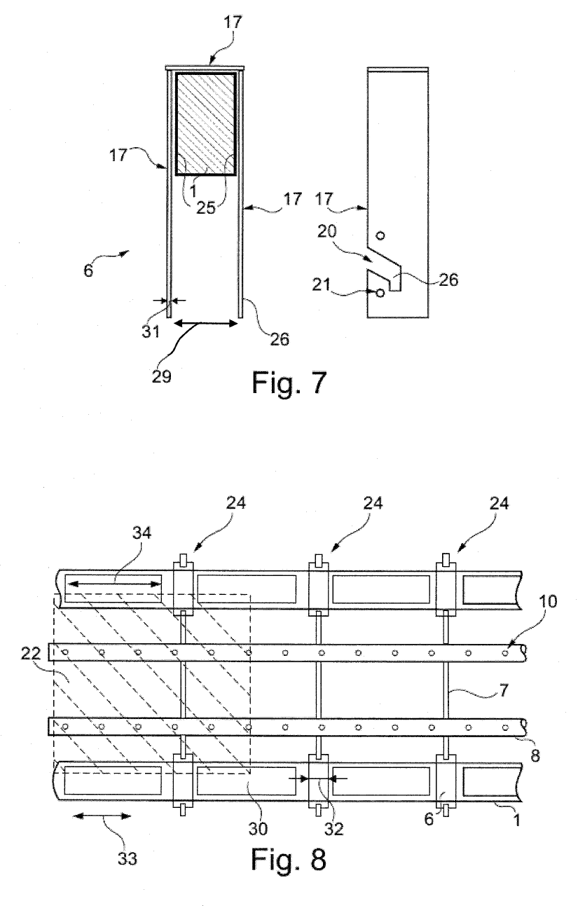

FIG. 7 shows a drawing of a detail of a suspension 6. The suspension 6 is produced from three plastic plates 17 which are shaped into a long-legged “U” by being welded together. Alternatively, this shape may be produced by the bending of a plastic plate 17. This U-shaped suspension 6 is then hung, upside-down, via the carrying beam 1, the width 29 of the middle plastic plate 7 corresponding (with tolerance) to the width 29 of the carrying beam 1. The ends or arms or mountings 26 consequently extend downwards beyond the sides 25 of the carrying beam 1. At the end of the long-legged arms of the suspension 6, indentations 20 are cut, into which the rectangular tube can be inserted. The indentation 20 in this case likewise has a rectangular shape. A bolt (not illustrated) is screwed to the prepared holes 21 with the aid of screws, with the result that the rectangular tube is secured against jumping out. The suspension 6 is produced with a material thickness 31 in the range of 8 mm to 10 mm.

FIG. 8 shows a further embodiment of the supporting structure 24 according to the invention after installation on the carrying beam 1, the drop separator modules 22 which later lie on it already being indicated here. The suspension 6 is formed, in turn, by 3 plastic plates (polypropylene), the mountings not having been welded perpendicularly to the base plate, but at another angle, particularly such that the upturned “U” widens or opens somewhat downwards. The suspension 6 has a width 32 in the direction of extent 33 of the carrying beam 1 in the range of 180 mm to 220 mm. It is illustrated here, further, that the flue-gas scrubber has a plurality of suspensions 6 which lie on a carrying beam 1 and are spaced apart in the direction of extent 33 of the carrying beam 1 by means of distance plates 30. The distance plates 30 have an average extent 34 in the direction of extent 33 of the carrying beam 1 of approximately 1000 mm to 1200 mm, but, if appropriate, may also be produced with different extents 34. The suspensions 6 are positioned (with some play) between the distance plates 30, so that suspensions 6 located opposite one another jointly hold a carrying bar 7, so that the nozzle-spraying pipes 8, together, are oriented with their spraying nozzles 10 with respect to the drop separator modules 22 in the desired way.

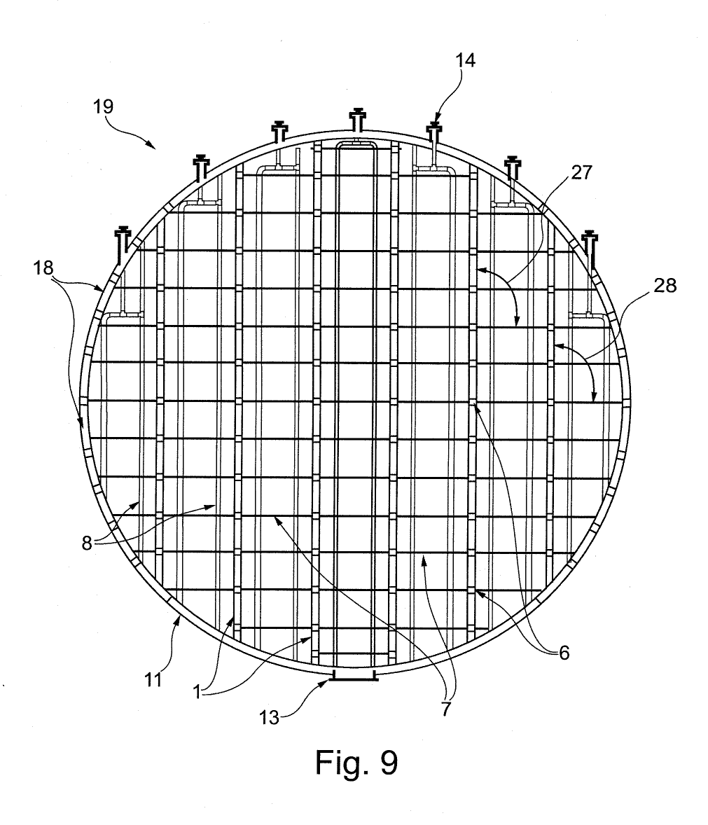

FIG. 9 shows a layout drawing with the nozzle-spraying pipes 8 and the suspensions 6 at the sides and in the middle. The absorber or flue-gas scrubber 19 is characterized, as a round housing, by the wall 11 and the manhole 13 for walking on the plant. Six carrying beams 1 and the side ring 18 carry the drop separator modules 22. The suspensions 6 hang via the carrying beams 1 and hold the carrying bars 7 for nozzle spraying. The actual nozzle-spraying pipes 8 lie on the carrying bar 7. The nozzle-spraying pipes 8 are led outwards through connection pieces 14. In the preferred configuration, the carrying bars 7 are laid at the first angle 27 of 90° to the carrying beams 1, so that the actual nozzle-spraying pipes 8 lie parallel to the carrying beams 1 (at a second angle 28 of likewise approximately 90° between carrying bar 7 and nozzle-spraying pipe 8). The advantage of this configuration is that the lower level can thereby be walked upon more easily, in particular the carrying beam 1 can be walked upon.

If appropriate, however, an alternative configuration may also be selected for the arrangement of the rectangular carrying tubes or carrying bar 7, these lying parallel to the carrying beams 1. The nozzle-spraying pipes 8 then lie therefore at a first angle 28 of 90° to the carrying beam 1. Under certain circumstances, as a result, a better dimensioning of nozzle spraying can be achieved or the connection pieces 14 can be adapted to a given configuration of the platforms. The latter is advantageous particularly in the replacement of older drop separators.

### LIST OF REFERENCE SYMBOLS

1 Carrying beam

2 Rest

3 Lamella

4 End plate

5 Middle plate

6 Suspension

7 Carrying bar

8 Nozzle-spraying pipe

9 Person

10 Spraying nozzle

11 Wall

12 Nozzle-spraying plant

13 Manhole

14 Connection piece

15 Slot

16 Distance

17 Plastic plate

18 Side ring

19 Flue-gas scrubber

20 Indentation

21 Hole

22 Drop separator module

23 Drop separator

24 Supporting structure

25 Side

26 Mounting

27 First angle

28 Second angle

29 Width

30 Distance plate

31 Material thickness

32 Width

33 Direction of extent

34 Extent

What is claimed is:

1. Flue-gas scrubber, comprising at least one horizontally installed drop separator module mounted by means of carrying beams and at least one nozzle-spraying plant having at least one nozzle-spraying pipe, the at least one nozzle-spraying plant being designed with a supporting structure for the nozzle-spraying pipes, characterized in that the supporting structure is designed with at least one suspension which at least partially surrounds a carrying beam and which has, for at least one carrying bar, mountings projecting on both sides of the carrying beam, this at least one carrying bar serving as a rest for the at least one nozzle-spraying pipe.

2. Flue-gas scrubber according to claim 1, characterized in that the suspension is designed in the form of a “U”, this being arranged with mountings projecting downwards beyond the carrying beam.

3. Flue-gas scrubber according to claim 1, characterized in that the suspension is formed by at least one plastic plate.

4. Flue-gas scrubber according to claim 1, characterized in that a plurality of suspensions lie on a carrying beam and are spaced apart in the direction of extent of the carrying beam by means of distance plates.

5. Flue-gas scrubber according to claim 1, characterized in that at least two suspensions are connected to one another via rectangular carrying bars.

6. Flue-gas scrubber according to claim 1, characterized in that the carrier bars are arranged parallel to the carrying beams.

7. Flue-gas scrubber according to claim 1, characterized in that the carrying bars are arranged at a first angle of 90° to the carrying beams.

8. Flue-gas scrubber according to claim 1, characterized in that the nozzle-spraying pipes lie at a second angle of 90° to the rectangular carrying bars.

9. Flue-gas scrubber according to claim 1, characterized in that the supporting structure is held at the intended location by virtue of its own weight and its shape and can consequently be removed again at any time with little outlay.

10. Flue-gas scrubber according to claim 1, characterized in that the nozzle-spraying pipes are secured against jumping out only by means of mountings having screws and stirrup pieces or having clips.
